(19) United States
(12) Patent Application Publication
(10) Pub. No.: US 2023/0316191 A1
(43) Pub. Date: Oct. 5, 2023

(54) WORKFLOW CONSISTENCY ENSURING DEVICE, WORKFLOW CONSISTENCY ENSURING METHOD, AND WORKFLOW CONSISTENCY ENSURING PROGRAM

(71) Applicant: Nippon Telegraph and Telephone Corporation, Tokyo (JP)

(72) Inventors: Kensuke TAKAHASHI, Musashino-shi, Tokyo (JP); Tomoki IKEGAYA, Musashino-shi, Tokyo (JP); Sho KANEMARU, Musashino-shi, Tokyo (JP); Tsuyoshi Toyoshima, Musashino-shi, Tokyo (JP)

(21) Appl. No.: 18/012,303

(22) PCT Filed: Jul. 2, 2020
(86) PCT No.: PCT/JP2020/026039

§ 371 Date: Dec. 22, 2022

(51) Int. Cl. G06Q 10/0633; G06F 9/54

(52) U.S. Cl. CPC G06Q 10/0633; G06F 9/542

(57) ABSTRACT

A workflow integrity ensuring device 2 includes: a workflow history saving unit 22 that stores therein workflow execution history management information indicating execution states of workflows related to controlled elements controlled by using a REST API; and a workflow integrity ensuring unit 23 that reads the workflow execution history management information from the workflow history saving unit 22, regularly understands the execution states of the workflows by using the workflow execution history management information, and deletes any of controlled elements 3 related to a workflow of which the execution state is indicated as having failed.

### TECHNICAL FIELD

The present invention relates to a workflow integrity ensuring device, a workflow integrity ensuring method, and a workflow integrity ensuring program.

### BACKGROUND ART

A method is known by which the substance of a requested service (service X) requested by a user is constructed by bringing a plurality of services A, B, C, and so on into collaboration with one another. More specifically, the requested service X is provided for the user, by generating the plurality of services A, B, C, and so on that collaborate with one another, while using a resource-oriented Application Programming Interface (API) such as a Representational State Transfer Application Programming Interface (REST API). For example, Patent Literature 1 discloses a method by which collaborating services are constructed while adding a new service and a new API, by combining a catalog with an adaptor.

### CITATION LIST

### Patent Literature

Patent Literature 1: Japanese Patent Laid-Open No. 2018-206050

### SUMMARY OF THE INVENTION

### Technical Problem

However, Patent Literature 1 merely discloses a method for bringing services A, B, C, and so on into collaboration with one another. Thus, there is a problem where, if a failure occurs while a workflow related to the services is being processed (e.g., while the requested service X is being constructed), it is not possible to ensure data integrity of entire workflows.

In view of the circumstances described above, it is an object of the present invention to provide a technique that makes it possible to ensure data integrity of entire workflows, even when a failure occurs while a workflow related to a plurality of services is being processed.

### Means for Solving the Problem

A workflow integrity ensuring device according to an aspect of the present invention includes: a storage unit that stores therein history information of execution states of workflows related to controlled elements controlled by using a Representational State Transfer Application Programming Interface (REST API); and a control unit that reads the history information from the storage unit, regularly understands the execution states of the workflows by using the history information, and deletes any of the controlled elements related to a workflow of which the execution state is indicated as having failed.

A workflow integrity ensuring method according to an aspect of the present invention causes the workflow integrity ensuring device to perform: a step of storing, into a storage unit, history information of execution states of workflows related to controlled elements controlled by using a Representational State Transfer Application Programming Interface (REST API); and a step of reading the history information from the storage unit, regularly understanding the execution states of the workflows by using the history information, and deleting any of the controlled elements related to a workflow of which the execution state is indicated as having failed.

A workflow integrity ensuring program according to an aspect of the present invention is a program that causes a computer to function as the above-mentioned workflow integrity ensuring device.

### Effects of the Invention

According to the present invention, even when a failure has occurred while a workflow related to a plurality of services is being processed, it is possible to ensure data integrity of the entire workflows.

### BRIEF DESCRIPTION OF DRAWINGS

FIG. 1 is a reference drawing used at the time of explaining problems.

FIG. 2 is a configuration diagram showing a configuration of a workflow integrity ensuring device.

FIG. 3 is a table showing parameter examples included in workflow execution history management information.

FIG. 4 is a diagram showing a specific example of a workflow execution process.

FIG. 5A is a table showing a specific example of workflow execution history management information.

FIG. 5B is another table showing the specific example of the workflow execution history management information.

FIG. 5C is yet another table showing the specific example of the workflow execution history management information.

FIG. 5D is yet another table showing the specific example of the workflow execution history management information.

FIG. 6 is a flowchart showing an operation to newly register a workflow execution history.

FIG. 7 is a flowchart showing an operation to register a change in a workflow execution history.

FIG. 8 is a flowchart showing an operation to register a failure in a workflow execution history.

FIG. 9 is a flowchart showing an operation to ensure workflow integrity.

FIG. 10 is a configuration diagram showing a hardware configuration of the workflow integrity ensuring device.

### DESCRIPTION OF EMBODIMENTS

The following will describe embodiments of the present invention, with reference to the drawings. Some of the elements in the drawings that are mutually the same will be referred to by using the same reference characters, and the explanations thereof will be omitted.

[1. An Outline of the Invention]

The present invention relates to a technique for providing a requested service (service X) requested by a user. In particular, the technique is related to bringing a plurality of services A, B, C, and so on into collaboration with one another that are necessary for providing the requested service X, by using a Representational State Transfer Application Programming Interface (REST API).

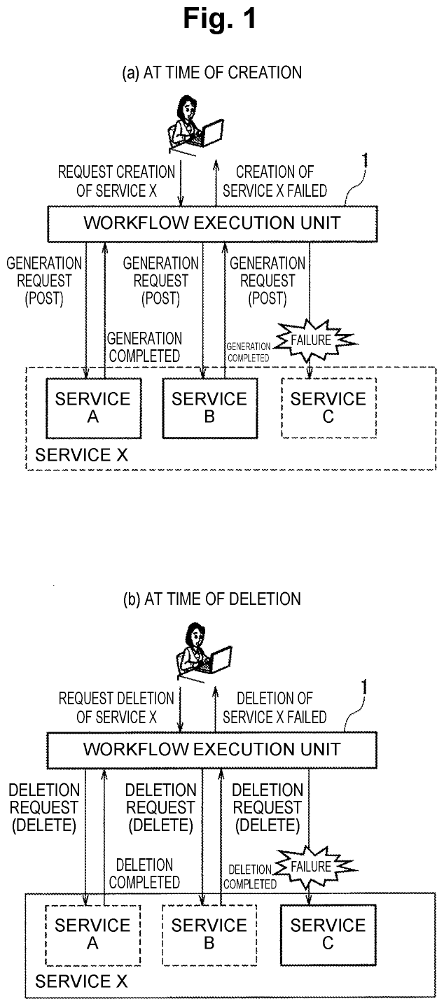

According to the conventional technique, it is not possible, as explained in the problem section above, to ensure the data integrity of the entire workflows, when a failure has occurred while a workflow related to a plurality of services A, B, and C is being processed. More specifically, as shown in FIG. 1(a), to create the requested service X, a workflow execution unit 1 transmits, to a server, a generation request (POST/serviceA) for generating service A, transmits a generation request (POST/serviceB) for service B after the generation of service A is completed, and transmits a generation request (POST/serviceC) for service C after the generation of service B is completed, by using the REST API. If a failure occurs at this time, service C will not be generated, and the requested service X will not be generated, either. However, because service A and service B have been generated, a situation thus arises where data integrity is not ensured. In this situation, service A and service B need to be deleted.

Further, as shown in FIG. 1(b), to delete the requested service X, the workflow execution unit 1 transmits, to the server, a deletion request (DELETE/serviceA) for deleting service A, transmits a deletion request (DELETE/serviceB) for service B after the deletion of service A is completed, and transmits a deletion request (DELETE/serviceC) for service C after the deletion of service B is completed, by using the REST API. If a failure has occurred at this time, service C will not be deleted, and the requested service X will not be deleted, either. However, because service A and service B have been deleted, a situation thus arises where data integrity is not ensured. In this situation, service C needs to be deleted.

To cope with these situations, the present invention is configured to manage an execution history of workflows executed by the workflow execution unit 1, to regularly check execution states (completed or failed) of the workflows by using the execution history, and to automatically delete the data of a resource in which, due to the occurrence of a failure, the execution state is indicated as “failed” and the data lacks integrity. More specifically, with respect to the content of the execution history of the workflows executed in relation to controlled elements (processing units of services A, B, C, and so on), the execution history is managed on the basis of identifiers of the workflows, execution times of the workflows, deletion APIs used for solving the non-integrity problems, and the like, while the occurrence of failures during the execution of the workflows is taken into consideration. Further, the integrity of the workflows is ensured on the basis of the execution history.

[2. A Configuration of a Workflow Integrity Ensuring Device]

[2.1. An Example of the Configuration of the Workflow Integrity Ensuring Device]

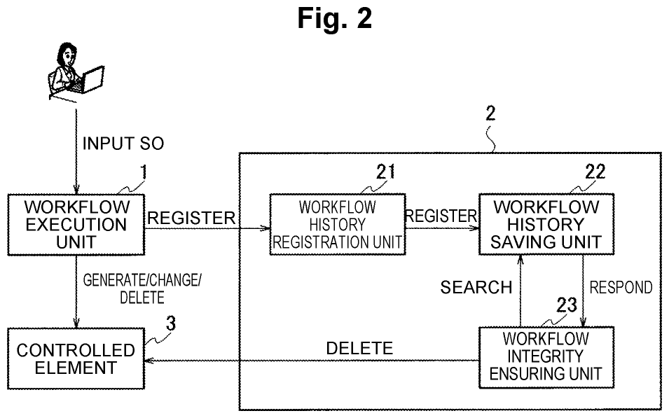

FIG. 2 is a configuration diagram showing a configuration of a workflow integrity ensuring device 2 according to the present embodiment. FIG. 2 also depicts the workflow execution unit (the execution unit) 1 that executes workflows related to controlled elements 3. The controlled elements 3 are the processing units (the substances of processes and a group of data necessary for the processes) of services A, B, C, and so on that are necessary for providing the requested service X requested by the user.

The workflow execution unit 1 has a function of receiving the request for the requested service X from a user terminal of the user and executing a workflow corresponding to the type (generation, change, or deletion) of the request. For example, upon receipt of an instruction to create the requested service X, the workflow execution unit 1 generates the plurality of services A, B, C, and so on necessary for providing the requested service X in a collaboration-enabled manner, by using the REST API. Upon receipt of an instruction to delete the requested service X, the workflow execution unit 1 deletes all the services A, B, C, and so on related to the requested service X, by using the REST API.

In the present embodiment, the workflow execution unit 1 has a function of transmitting a copy of the data processed at the time of executing a workflow to the workflow integrity ensuring device 2 as history information of the workflow execution and having the copy registered into a workflow history registration unit 21 of the workflow integrity ensuring device 2.

Next, the workflow integrity ensuring device 2 will be explained. As shown in FIG. 2, the workflow integrity ensuring device 2 includes the workflow history registration unit 21, a workflow history saving unit 22, and a workflow integrity ensuring unit 23.

The workflow history registration unit (the registration unit) 21 has a function of receiving the copy of the data (the history information) from the workflow execution unit 1 and registering the copy into the workflow history saving unit 22 as workflow execution history management information. In this situation, the workflow history registration unit 21 performs a hidden registration process to register the data from the workflow execution unit 1 into the workflow history saving unit 22, regardless of the workflow execution process performed by the workflow execution unit 1. The workflow execution unit 1 simply gives the data to the workflow history registration unit 21 without being aware of the registration process of the workflow history registration unit 21 (an internal process of the workflow integrity ensuring device 2). Thus, the registration process is regarded as the “hidden registration process”.

The workflow history saving unit (the storage unit) 22 has a function of storing therein the workflow execution history management information registered by the workflow history registration unit 21. In other words, the workflow history saving unit 22 stores therein the history information of execution states of the workflows related to the controlled elements 3 controlled by the workflow execution unit 1 while using the REST API.

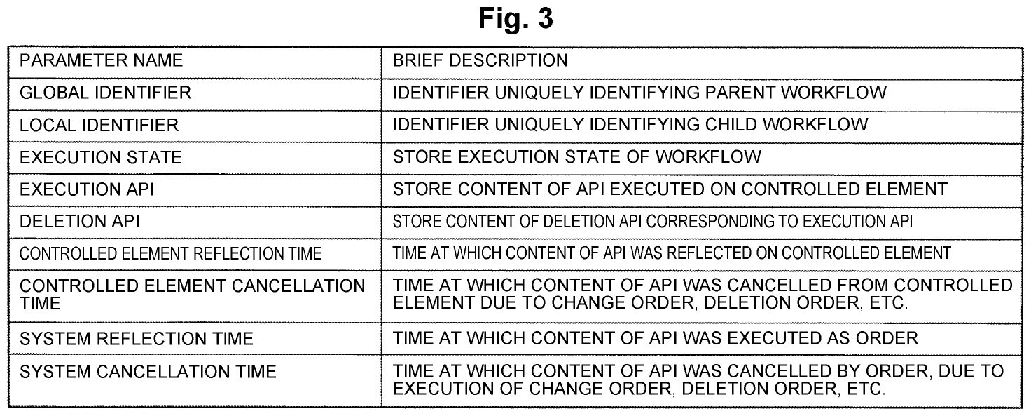

FIG. 3 is a table showing parameter examples included in the workflow execution history management information. For example, the workflow execution history management information saves therein the following so as to be kept in association with one another: a “global identifier” uniquely identifying a parent workflow in an upper layer; a “local identifier” uniquely identifying a child workflow in a lower layer; an “execution state” indicating an execution state (underway, completed, or failed) of the workflow; an “execution API” indicating the content of the API executed on the controlled element 3; a “deletion API” for deleting the content of the execution API; a “controlled element reflection time” indicating a time at which the content of the API was reflected on the controlled element 3; a “controlled element cancellation time” indicating a time at which the content of the API was cancelled from the controlled element 3 due to a change order, a deletion order, or the like; a “system reflection time” indicating a time at which the content of the API was executed as an order; and a “system cancellation time” indicating a time at which the content of the API was cancelled by an order due to execution of a change order, a deletion order, or the like. In the workflow execution history management information, these parameters are saved for each workflow.

The workflow integrity ensuring unit (the control unit) 23 has a function of reading the workflow execution history management information from the workflow history saving unit 22, regularly checking the execution states of the workflows by using the read workflow execution history management information, and deleting any of the controlled elements 3 related to a workflow of which the execution state is indicated as “failed”. More specifically, the workflow integrity ensuring unit 13 deletes any of the controlled elements 3 related to the workflow of which the execution state is indicated as “failed”, by searching for the identifier (the global identifier, the local identifier) of the workflow of which the execution state is indicated as “failed” on the basis of the execution times (the controlled element reflection times, the system reflection times) of the workflows and obtaining and executing a deletion API corresponding to the identifier of the workflow found in the search.

[2.2. Advantageous Effects of the Configuration of the Workflow Integrity Ensuring Device]

In the present embodiment, on the basis of the identifiers of the workflows, the execution states of the workflows, the execution times of the workflows, the controlled element reflection times, and the deletion APIs used for solving the non-integrity problems, the workflow history saving unit 22 manages the workflow execution history of the workflow execution unit 1, so that the workflow integrity ensuring unit 23 deletes any of the controlled elements 3 related to a workflow of which the execution state is indicated as “failed”. Consequently, it is possible to ensure the data integrity.

In particular, because the deletion APIs are stored in the workflow execution history management information, it is possible to realize the deletion of the controlled elements 3 easily and with certainty. Further, when a resource-oriented API such as the REST API is used, because a deletion-purpose API corresponding to the generation resource is already present, it is possible to utilize the deletion-purpose API as it is.

Further, in the present embodiment, because the hierarchical identifiers such as the global identifiers and the local identifiers are used, even when the workflows have a hierarchical multi-layered structure, it is possible to properly manage the workflow execution history related to the workflows having the multi-layered structure.

Further, in the present embodiment, the managed information includes information related to a time axis, such as the controlled element reflection times and the controlled element cancellation times indicating the reflection on the controlled element 3, as well as the system reflection times and the system cancellation times indicating the execution of the orders. Consequently, it is possible to easily search for the most up-to-date state on the basis of the current time at the time of the search.

[3. An Operation of the Workflow Integrity Ensuring Device]

[3.1. A Specific Example of the Workflow Execution History Management]

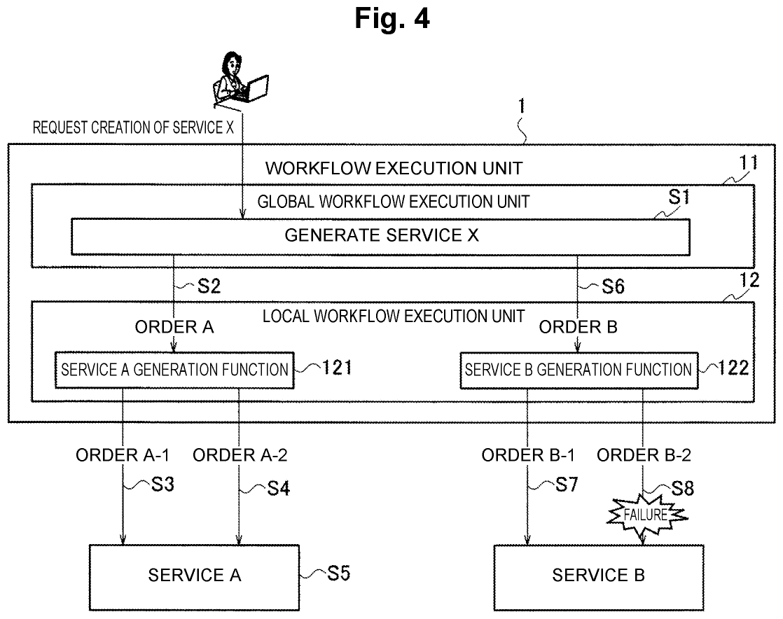

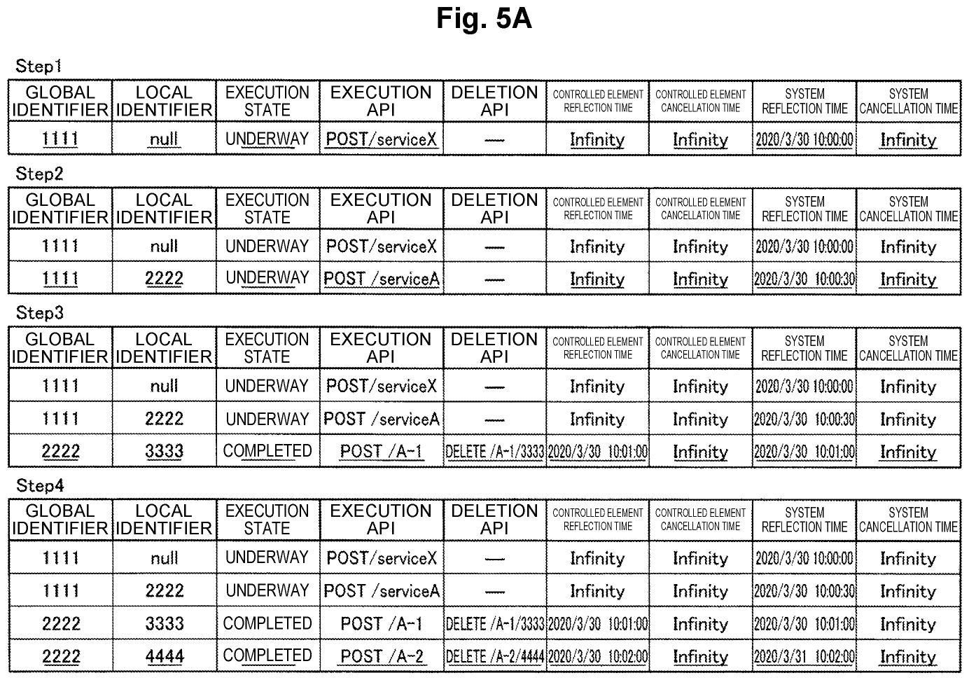

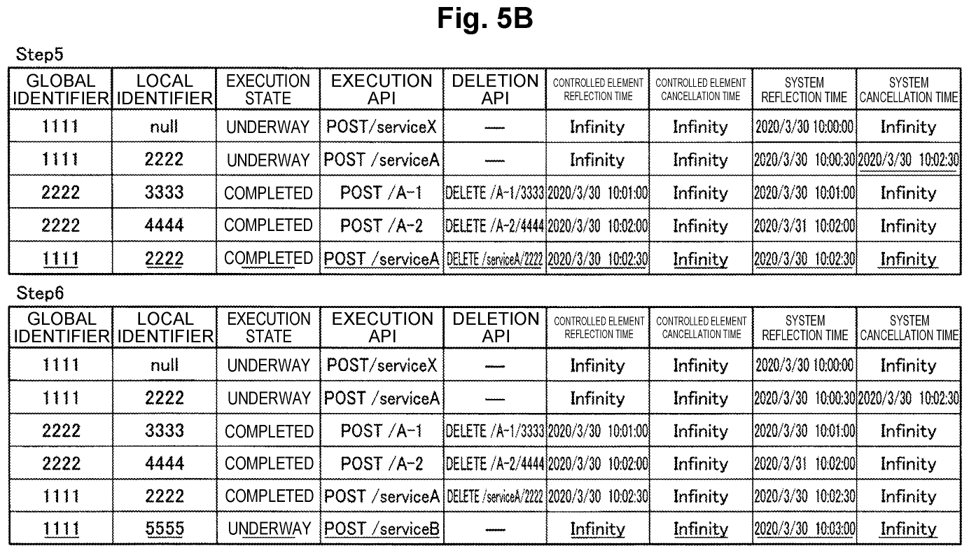

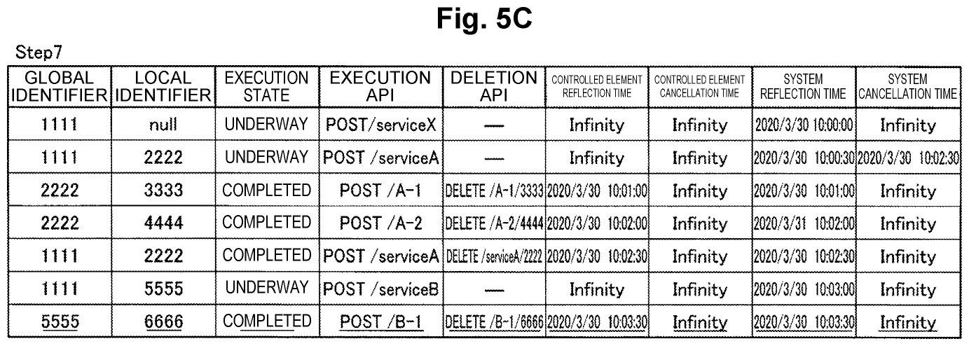

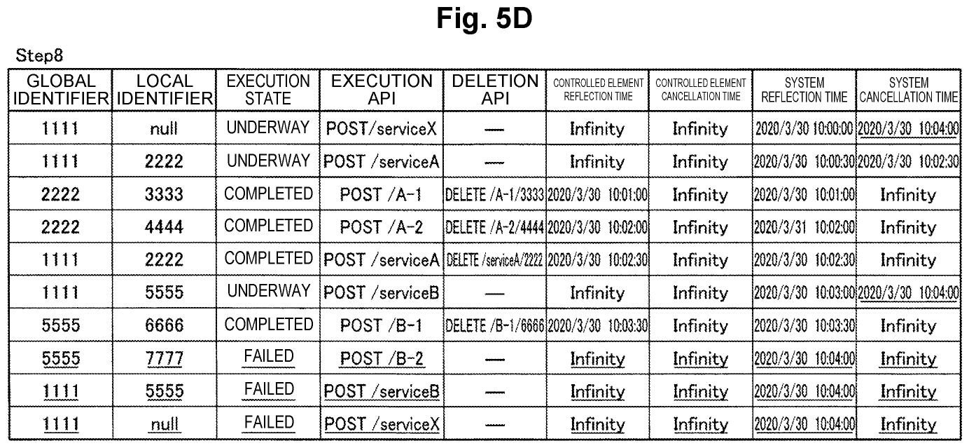

FIG. 4 is a diagram showing a specific example of a workflow execution process. FIGS. 5A to 5D are tables showing a specific example of the workflow execution history management information updated in accordance with the workflow execution process shown in FIG. 4. In the present example, a situation will be explained in which the requested service X structured with service A and service B is to be generated. Further, it is assumed that the workflows are separated in the following two layers: a global workflow for generating both service A and service B to generate the requested service X; and a local workflow for generating service A and service B. The number of hierarchical layers of the workflow does not need to be two and may be three or more.

In this situation, the services and the orders will be further explained. The “services” denotes services actually used by the user, e.g., a subscription to an electronic magazine. The “orders” denotes inputting various necessary settings to a server or a computer system so as to make it possible to provide the “services” requested by users.

Step S1:

When the user requests the requested service X, a global workflow execution unit 11 of the workflow execution unit 1 generates (POST/serviceX) the requested service X. In this situation, the workflow history registration unit 21 of the workflow integrity ensuring device 2 registers the following in the first line of the workflow execution history management information:
the “global identifier”: “1111” (=the identifier of the requested service X);
the “local identifier”: “null”;
the “execution state”: “underway”;
the “execution API”: “POST/serviceX”;
the “deletion API”: “−”;
the “controlled element reflection time”: “Infinity”;
the “controlled element cancellation time”: “Infinity”;
the “system reflection time”: “2020/3/30 10:00:00” (=the current time); and
the “system cancellation time”: “Infinity”.

Step S2:

Subsequently, the global workflow execution unit 11 invokes a service A generation function 121 of a local workflow execution unit 12 and causes the invoked service A generation function 121 to execute (POST/serviceA) a generation workflow for service A. In this situation, the workflow history registration unit 21 registers the following in the second line of the workflow execution history management information:
the “global identifier”: “1111” (=the identifier of the requested service X);
the “local identifier”: “2222” (=the identifier of service A);
the “execution state”: “underway”;
the “execution API”: “POST/serviceA”;
the “deletion API”: “-”;
the “controlled element reflection time”: “Infinity”;
the “controlled element cancellation time”: “Infinity”;
the “system reflection time”: “2020/3/30 10:00:30” (=the current time); and
the “system cancellation time”: “Infinity”.

Step S3:

After that, the global workflow execution unit 11 is notified by the service A generation function 121 that order A-1 was executed (POST/A-1) for service A and that a normal response was returned from service A with regard to the execution of order A-1. I this situation, the workflow history registration unit 21 registers the following in the third line of the workflow execution history management information:
the “global identifier”: “2222” (=the identifier of service A);
the “local identifier”: “3333” (=the identifier of order A-1);
the “execution state”: “completed”;
the “execution API”: “POST/A-1”;
the “deletion API”: “DELETE/A-1/3333”;
the “controlled element reflection time”: “2020/3/30 10:01:00” (=the current time);
the “controlled element cancellation time”: “Infinity”;
the “system reflection time”: “2020/3/30 10:01:00” (=the current time); and
the “system cancellation time”: “Infinity”. The “deletion API”: “DELETE/A-1/3333” denotes an API for deleting order A-1. By executing the deletion API, it is possible to delete order A-1.

Step S4:

Subsequently, the global workflow execution unit 11 is notified by the service A generation function 121 that order A-2 was executed (POST/A-2) for service A and that a normal response was returned from service A with regard to the execution of order A-2. In this situation, the workflow history registration unit 21 registers the following in the fourth line of the workflow execution history management information:
the “global identifier”: “2222” (=the identifier of service A);
the “local identifier”: “4444” (=the identifier of order A-2);
the “execution state”: “completed”;
the “execution API”: “POST/A-2”;
the “deletion API”: “DELETE/A-2/4444”;
the “controlled element reflection time”: “2020/3/30 10:02:00” (=the current time);
the “controlled element cancellation time”: “Infinity”;
the “system reflection time”: “2020/3/30 10:02:00” (=the current time); and
the “system cancellation time”: “Infinity”. The “deletion API”: “DELETE/A-1/4444” denotes an API for deleting order A-2. By executing the deletion API, it is possible to delete order A-2.

Step S5:

The generation of service A was completed in step S4. In this situation, the workflow history registration unit 21 registers the following in the fifth line of the workflow execution history management information:
the “global identifier”: “1111” (=the identifier of the requested service X);
the “local identifier”: “2222” (=the identifier of service A);
the “execution state”: “completed”;
the “execution API”: “POST/serviceA”;
the “deletion API”: “DELETE/serviceA/2222”;
the “controlled element reflection time”: “2020/3/30 10:02:30” (=the current time);
the “controlled element cancellation time”: “Infinity”;
the “system reflection time”: “2020/3/30 10:02:30” (=the current time); and
the “system cancellation time”: “Infinity”. The “deletion API”: “DELETE/serviceA/2222” denotes an API for deleting service A. By executing the deletion API, it is possible to delete service A and all the orders (order A-1 and order A-2) associated with service A. Further, also as the “system cancellation time” of the record in the second line related to the generation process of service A, “2020/3/30 10:02:30” (=the current time) is registered.

Step S6:

Subsequently, the global workflow execution unit 11 invokes a service B generation function 122 of the local workflow execution unit 12 and causes the invoked service B generation function 122 to execute (POST/serviceB) a generation workflow for service B. In this situation, the workflow history registration unit 21 registers the following in the sixth line of the workflow execution history management information:
the “global identifier”: “1111” (=the identifier of the requested service X);
the “local identifier”: “5555” (=the identifier of service B);
the “execution state”: “underway”;
the “execution API”: “POST/serviceB”;
the “deletion API”: “-”;
the “controlled element reflection time”: “Infinity”;
the “controlled element cancellation time”: “Infinity”;
the “system reflection time”: “2020/3/30 10:03:00” (=the current time); and
the “system cancellation time”: “Infinity”.

Step S7:

After that, the global workflow execution unit 11 is notified by the service B generation function 122 that order B-1 was executed (POST/B-1) for service B and that a normal response was returned from service B with regard to the execution of order B-1. In this situation, the workflow history registration unit 21 registers the following in the seventh line of the workflow execution history management information:
the “global identifier”: “5555” (=the identifier of service B);
the “local identifier”: “6666” (=the identifier of order B-1);
the “execution state”: “completed”;
the “execution API”: “POST/B-1”;
the “deletion API”: “DELETE/B-1/6666”;
the “controlled element reflection time”: “2020/3/30 10:03:30” (=the current time);
the “controlled element cancellation time”: “Infinity”;
the “system reflection time”: “2020/3/30 10:03:30” (=the current time); and
the “system cancellation time”: “Infinity”. The “deletion API”: “DELETE/B-1/6666” denotes an API for deleting order B-1. By executing the deletion API, it is possible to delete order B-1.

Step S8:

Subsequently, as for the global workflow execution unit 11, although the service B generation function 122 executes (POST/B-2) order B-2 for service B, the execution fails due to a communication failure. In this situation, the workflow history registration unit 21 registers the following in the eighth line of the workflow execution history management information:
the “global identifier”: “5555” (=the identifier of service B);
the “local identifier”: “7777” (=the identifier of order B-2);
the “execution state”: “failed”;
the “execution API”: “POST/B-2”;
the “deletion API”: “-”;
the “controlled element reflection time”: “Infinity”;
the “controlled element cancellation time”: “Infinity”;
the “system reflection time”: “2020/3/30 10:04:00” (=the current time); and
the “system cancellation time”: “Infinity”.

Also, the following is registered in the ninth line of the workflow execution history management information:
the “global identifier”: “1111” (=the identifier of the requested service X);
the “local identifier”: “5555” (=the identifier of service B);
the “execution state”: “failed”;
the “execution API”: “POST/serviceB”;
the “deletion API”: “−”;
the “controlled element reflection time”: “Infinity”;
the “controlled element cancellation time”: “Infinity”;

the “system reflection time”: “2020/3/30 10:04:00” (=the current time); and
the “system cancellation time”: “Infinity”.

In addition, the following is registered in the tenth line of the workflow execution history management information:
the “global identifier”: “1111” (=the identifier of the requested service X);
the “local identifier”: “null”;
the “execution state”: “failed”;
the “execution API”: “POST/serviceX”;
the “deletion API”: “-”;
the “controlled element reflection time”: “Infinity”;
the “controlled element cancellation time”: “Infinity”;
the “system reflection time”: “2020/3/30 10:04:00” (=the current time); and
the “system cancellation time”: “Infinity”. Furthermore, also as the “system cancellation times” of the record in the first line related to the generation request for the requested service X and of the record in the sixth line related to the generation request for service B, “2020/3/30 10:04:00” (=the current time) is registered.

[3.2. A Specific Example of the Data Integrity]

On the basis of the records in the eighth to the tenth lines of the workflow execution history management information shown in FIG. 5D, the generation of order B-2, service B, and the requested service X failed. Further, on the basis of the records in the third to the fifth and the seventh lines, the generation of order A-1, order A-2, service A, and order B-1 have been completed, but the data lacks integrity.

To cope with this situation, the workflow integrity ensuring unit 23 deletes order A-1, order A-2, service A, and order B-1, by obtaining and executing the deletion APIs necessary for ensuring the data integrity, out of the workflow execution history management information. As a result, the data integrity related to the requested service X is ensured. The workflow execution history management information is managed on the basis of the time axis and the execution states (underway, completed, or failed) of the workflows. Consequently, by executing the following procedures on the basis of these factors, it is possible to ensure the data integrity.

Procedure 1:

The workflow integrity ensuring unit 23 obtains the global identifier “1111” (=the identifier of the requested service X) lacking integrity, by using a search expression “local identifier=null AND execution state=failed AND system reflection time<current time AND system cancellation time≥current time”.

Procedure 2:

Subsequently, the workflow integrity ensuring unit 23 obtains the deletion API for “service A” relevant to the requested service X lacking integrity, by using a search expression “global identifier=1111 AND controlled element reflection time<current time AND system cancellation time current time”.

Procedure 3:

After that, the workflow integrity ensuring unit 23 obtains the local identifier “5555” of “service B” relevant to the requested service X lacking integrity, by using a search expression “global identifier=1111 AND controlled element reflection time current time AND system cancellation time current time”.

Procedure 4:

Subsequently, the workflow integrity ensuring unit 23 obtains the deletion API for “order B-1” relevant to the requested service X lacking integrity, by using a search expression “global identifier=5555 AND controlled element reflection time<current time AND system cancellation time current time”.

Procedure 5:

Lastly, the workflow integrity ensuring unit 23 executes the deletion API for “service A” obtained in Procedure 2 and executes the deletion API for “order B-1” obtained in Procedure 4. As a result, because order A-1, order A-2, service A, and order B-1 are deleted, the non-integrity problem of the data is solved.

[3.3. An Operation of the Workflow History Registration Unit]

As explained above in the specific example of the workflow execution history management, managing the workflow execution history requires that the update process and the newly set-up process be performed on the history information in units of workflow execution. The workflow history registration unit 21 hides these processes and registers a workflow execution history in accordance with each of the different types such as a new registration, a change, and a failure.

In this situation, “hiding” denotes that the workflow execution unit 1 does not need to be aware of the internal process of the workflow history registration unit 21. The workflow execution unit 1 simply gives a copy of the data processed at the time of execution of the workflow to the workflow history registration unit 21, so that the process of ensuring the data integrity is performed by the workflow integrity ensuring device 2, which is a processing party different from the workflow execution unit 1. The workflow execution unit 1 is thus able to focus on the workflow execution process and is released from trouble of having to perform the data integrity ensuring process.

[3.3.1. An Operation for a New Registration]

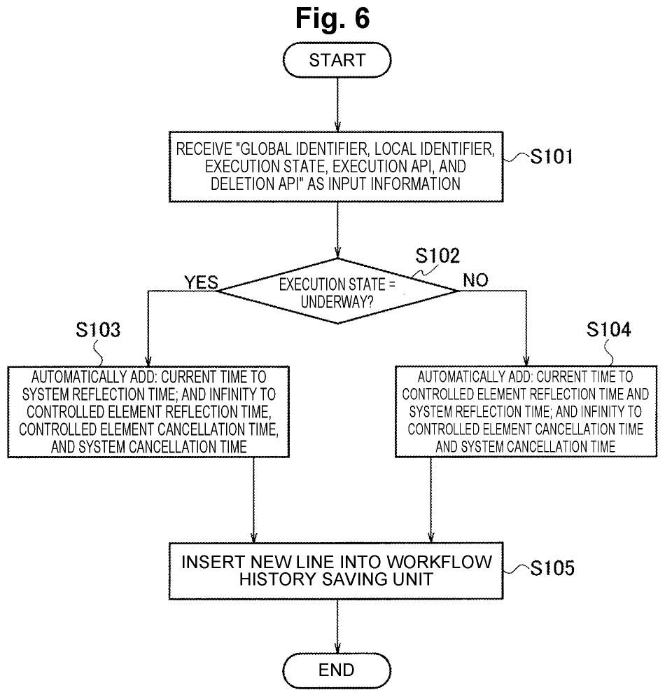

An operation to newly register a workflow execution history will be explained. FIG. 6 is a flowchart showing an operation to newly register a workflow execution history.

Step S101:

The workflow history registration unit 21 receives a “global identifier”, a “local identifier”, an “execution state”, an “execution API”, and a “deletion API” from the workflow execution unit 1, as input information.

Step S102:

Subsequently, the workflow history registration unit 21 determines whether or not the “execution state” in the input information indicates “underway”. When the “execution state” indicates “underway”, the process proceeds to step S103. When the “execution state” does not indicate “underway”, the process proceeds to step S104.

Step S103:

When the “execution state” in the input information indicates “underway”, the workflow history registration unit 21 automatically adds the “current time” to the “system reflection time” and automatically adds “Infinity” to the “controlled element reflection time”, the “controlled element cancellation time”, and the “system cancellation time”. After that, the process proceeds to step S105.

Step S104:

When the “execution state” in the input information does not indicate “underway”, the workflow history registration unit 21 automatically adds the “current time” to the “controlled element reflection time” and the “system reflection time” and automatically adds “Infinity” to the “controlled element cancellation time” and the “system cancellation time”. After that the process proceeds to step S105.

Step S105:

Lastly, the workflow history registration unit 21 adds the input information to which the information was automatically added in step S103 or step S104, to the last line of the workflow execution history management information.

[3.3.2. An Operation to Register a Change]

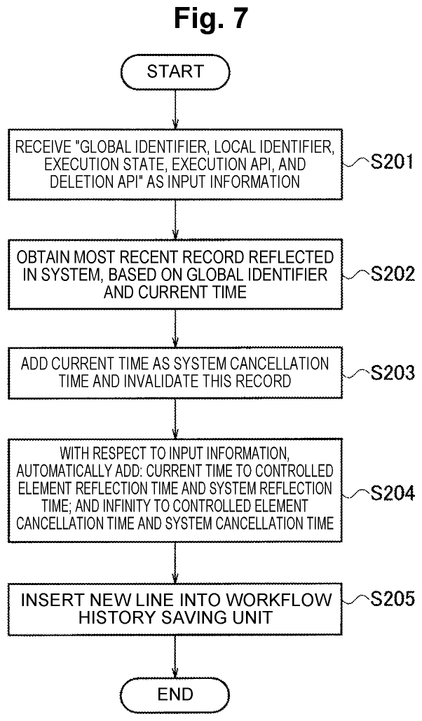

An operation to register a change in a workflow execution history will be explained. FIG. 7 is a flowchart showing an operation to register a change in a workflow execution history.

Step S201:

The workflow history registration unit 21 receives a “global identifier”, a “local identifier”, an “execution state”, an “execution API”, and a “deletion API” from the workflow execution unit 1, as input information.

Step S202:

Subsequently, the workflow history registration unit 21 obtains a record in which the “global identifier” in the workflow execution history management information matches the “global identifier” in the input information, while the “system reflection time” in the workflow execution history management information is the most recent time.

Step S203:

After that, the workflow history registration unit 21 automatically adds the “current time” as the “system cancellation time” in the obtained record and invalidates the record.

Step S204:

Subsequently, with respect to the input information in step S201, the workflow history registration unit 21 automatically adds the “current time” to the “controlled element reflection time” and the “system reflection time” and automatically adds “Infinity” to the “controlled element cancellation time” and “system cancellation time”.

Step S205:

Lastly, the workflow history registration unit 21 adds the input information to which the information was automatically added, to the last line of the workflow execution history management information.

[3.3.3. An Operation to Register a Failure]

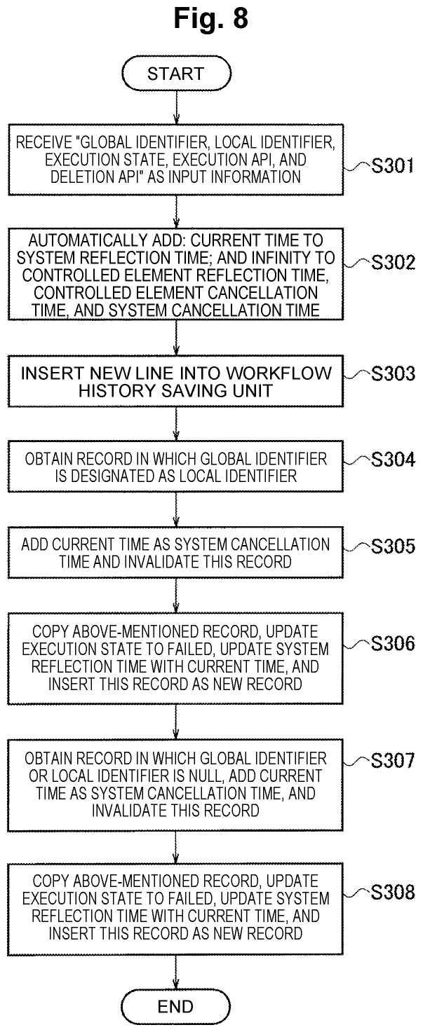

An operation to register a failure in a workflow execution history will be explained. FIG. 8 is a flowchart showing an operation to register a failure in a workflow execution history.

Step S301:

The workflow history registration unit 21 receives a “global identifier”, a “local identifier”, an “execution state”, an “execution API”, and a “deletion API” from the workflow execution unit 1, as input information.

Step S302:

Subsequently, the workflow history registration unit 21 automatically adds the “current time” to the “system reflection time” and automatically adds “Infinity” to the “controlled element reflection time”, the “controlled element cancellation time”, and the “system cancellation time”.

Step S303:

After that, the workflow history registration unit 21 adds the input information to which the information was automatically added, to the last line of the workflow execution history management information.

Step S304:

Subsequently, the workflow history registration unit 21 obtains a record in which the “global identifier” in the input information is designated as a “local identifier” in the workflow execution history management information.

Step S305:

Subsequently, the workflow history registration unit 21 automatically adds the “current time” as the “system cancellation time” in the obtained record and invalidates the record.

Step S306:

After that, the workflow history registration unit 21 makes a copy of the invalidated record, updates the “execution state” to indicate “failed”, updates the “system reflection time” with the “current time”, and adds the updated record as a new record to the last line of the workflow execution history management information.

Step S307:

Subsequently, the workflow history registration unit 21 obtains a record in which either the “global identifier” or the “local identifier” in the workflow execution history management information indicates “null”, further adds the “current time” as the “system cancellation time”, and invalidates the record.

Step S308:

After that, the workflow history registration unit 21 makes a copy of the record invalidated in step S307, updates the “execution state” to indicate “failed”, updates the “system reflection time” with the “current time”, and adds the updated record to the last line of the workflow execution history management information as a new record.

[3.4. An Operation Performed by the Workflow Integrity Ensuring Unit]

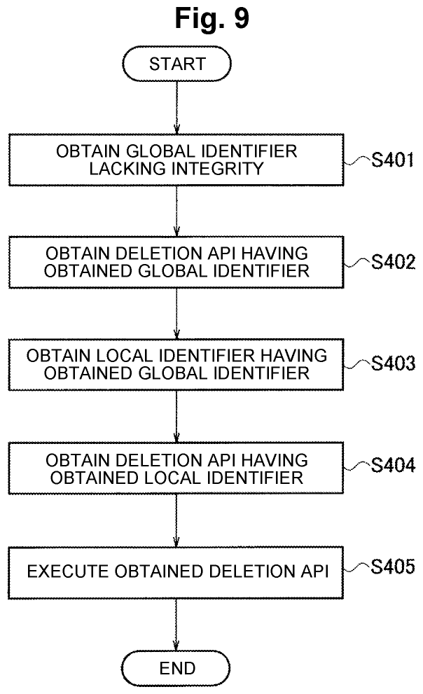

An operation performed by the workflow integrity ensuring unit 23 will be explained. FIG. 9 is a flowchart showing a workflow integrity ensuring operation. Steps S401 through S405 described below correspond to Procedures 1 to 5 described above.

Step S401:

The workflow integrity ensuring unit 23 obtains, out of the workflow execution history management information, a global identifier of which the “local identifier” is “null”, the “execution state” is “failed”, the “system reflection time” is earlier than the “current time”, and the “system cancellation time” is equal to or later than the “current time”.

Step S402:

Subsequently, the workflow integrity ensuring unit 23 obtains, out of the workflow execution history management information, the deletion API included in a record of which the “global identifier” matches the obtained global identifier, the “controlled element reflection time” is earlier than the “current time”, and the “system cancellation time” is equal to or later than the “current time”.

Step S403:

Subsequently, the workflow integrity ensuring unit 23 obtains, out of the workflow execution history management information, the local identifier included in a record of which the “global identifier” matches the global identifier obtained in step S401, the “controlled element reflection time” is equal to or later than the “current time”, and the “system cancellation time” is equal to or later than the “current time”.

Step S404:

After that, the workflow integrity ensuring unit 23 obtains, out of the workflow execution history management information, the deletion API included in a record of which the “global identifier” matches the local identifier obtained in step S403, the “controlled element reflection time” is earlier than the “current time”, and the “system cancellation time” is equal to or later than the “current time”.

Step S405:

Lastly, the workflow integrity ensuring unit 23 executes the deletion APIs obtained in step S402 and in step S404. Consequently, it is possible to solve the data non-integrity problem.

[4. Advantageous Effects of the Embodiment]

According to the present embodiment, the workflow integrity ensuring device 2 includes: the workflow history saving unit 22 that stores therein the workflow execution history management information indicating the execution states of the workflows related to the controlled elements controlled by using the REST API; and the workflow integrity ensuring unit 23 that reads the workflow execution history management information from the workflow history saving unit 22, regularly understands the execution states of the workflows by using the workflow execution history management information, and deletes any of the controlled elements 3 related to a workflow of which the execution state is indicated as having failed. Consequently, even when a failure has occurred while a workflow related to the plurality of services is being processed, it is possible to ensure the data integrity of the entire workflows.

[5. Others]

The present invention is not limited to the embodiments described above. It is possible to apply various modifications to the present invention within the scope of the gist of the present invention.

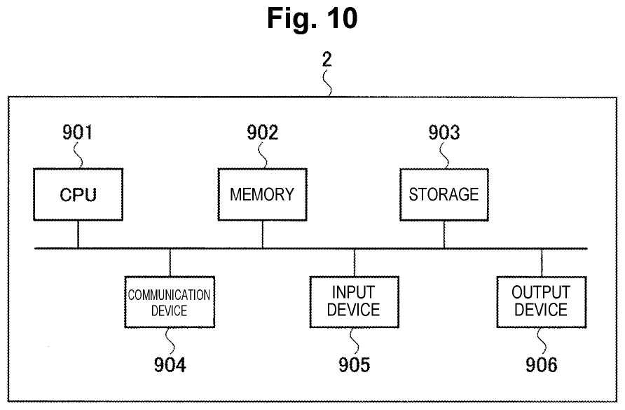

For example, as shown in FIG. 10, it is possible to realize the workflow integrity ensuring device 2 according to the present embodiment described above, by using a generic computer system including a Central Processing Unit (CPU, a processor) 901, a memory 902, a storage (a Hard Disk Drive [HDD]/a Solid State Drive [SSD]) 903, a communication device 904, an input device 905, and an output device 906. The memory 902 and the storage 903 are storage devices. In the computer system, the functions of the workflow integrity ensuring device 2 are realized as a result of the CPU 901 executing a prescribed program loaded into the memory 902.

The workflow integrity ensuring device 2 may be implemented as a single computer. The workflow integrity ensuring device 2 may be implemented as a plurality of computers. The workflow integrity ensuring device 2 may be a virtual machine installed in a computer.

The program for the workflow integrity ensuring device 2 may be stored in a computer-readable recording medium such as an HDD, an SSD, a Universal Serial Bus (USB) memory, a Compact Disc (CD), or a Digital Versatile Disc (DVD). The program for the workflow integrity ensuring device 2 may also be distributed via a communication network.

### REFERENCE SIGNS LIST

1 Workflow execution unit
2 Workflow integrity ensuring device
3 Controlled element
11 Global workflow execution unit
12 Local workflow execution unit
21 Workflow history registration unit
22 Workflow history saving unit
23 Workflow integrity ensuring unit
121 Service A generation function
122 Service B generation function
901 CPU
902 Memory
903 Storage
904 Communication device
905 Input device
906 Output device

1. A workflow integrity ensuring device comprising one or more processors configured to:
store therein history information of execution states of workflows related to controlled elements controlled by using a Representational State Transfer Application Programming Interface (REST API); and
read the history information from the storage unit;
regularly understand the execution states of the workflows by using the history information; and
delete any of the controlled elements related to a workflow of which the execution state is indicated as having failed.

2. The workflow integrity ensuring device according to claim 1, wherein
with respect to each of the workflows, the one or more processors are configured to:
store therein, so as to be kept in association with one another, an identifier of the workflow, the execution state of the workflow, an execution time of the workflow, and a deletion Application Programming Interface (API) for deleting the workflow; and
delete any of the controlled elements related to the workflow of which the execution state is indicated as having failed, by searching for the identifier of the workflow of which the execution state is indicated as having failed based on the execution time of the workflow and obtaining and executing the deletion API corresponding to the identifier of the workflow found in the search.

3. The workflow integrity ensuring device according to claim 2, wherein
the workflows are workflows having a multi-layered structure,
as the identifiers of the workflows, the one or more processors are configured to store therein an identifier of a workflow in an upper layer and an identifier of a workflow in a lower layer so as to be kept in association with each other, and
as the execution times of the workflows, the one or more processors are configured to store therein a controlled element reflection time at which content of the REST API was reflected on the controlled element and a system reflection time at which the content of the REST API was executed as an order.

4. The workflow integrity ensuring device according to claim 3, wherein the one or more processors are further configured to:
perform, regardless of a workflow execution process performed by an execution unit that executes the workflows related to the controlled elements, a hidden registration process to register pieces of data in the history information received from the execution unit into the storage unit.

5. The workflow integrity ensuring device according to claim 4, wherein
the controlled elements are a plurality of service processing units for providing a requested service.

6. A workflow integrity ensuring method implemented by a workflow integrity ensuring device, the workflow integrity ensuring device performing:
storing, into a storage unit, history information of execution states of workflows related to controlled elements controlled by using a Representational State Transfer Application Programming Interface (REST API); and
reading the history information from the storage unit, regularly understanding the execution states of the workflows by using the history information, and deleting any of the controlled elements related to a workflow of which the execution state is indicated as having failed.

7. A non-transitory computer-readable medium storing software comprising instructions executable by one or more processors which, upon such execution, cause the one or more processors to perform operations comprising:
storing, into a storage unit, history information of execution states of workflows related to controlled elements controlled by using a Representational State Transfer Application Programming Interface (REST API); and
reading the history information from the storage unit, regularly understanding the execution states of the workflows by using the history information, and deleting any of the controlled elements related to a workflow of which the execution state is indicated as having failed.

8. The non-transitory computer-readable medium according to claim 7, wherein with respect to each of the workflows,
storing therein, so as to be kept in association with one another, an identifier of the workflow, the execution state of the workflow, an execution time of the workflow, and a deletion Application Programming Interface (API) for deleting the workflow; and
deleting any of the controlled elements related to the workflow of which the execution state is indicated as having failed, by searching for the identifier of the workflow of which the execution state is indicated as having failed based on the execution time of the workflow and obtaining and executing the deletion API corresponding to the identifier of the workflow found in the search.

9. The non-transitory computer-readable medium according to claim 8, wherein the workflows are workflows having a multi-layered structure, as the identifiers of the workflows,
storing therein an identifier of a workflow in an upper layer and an identifier of a workflow in a lower layer so as to be kept in association with each other; and
as the execution times of the workflows, storing therein a controlled element reflection time at which content of the REST API was reflected on the controlled element and a system reflection time at which the content of the REST API was executed as an order.

10. The non-transitory computer-readable medium according to claim 9, further comprising: performing, regardless of a workflow execution process performed by an execution unit that executes the workflows related to the controlled elements, a hidden registration process to register pieces of data in the history information received from the execution unit into the storage unit.

11. The non-transitory computer-readable medium according to claim 10, wherein the controlled elements are a plurality of service processing units for providing a requested service.

12. The workflow integrity ensuring method according to claim 6, wherein with respect to each of the workflows,
storing therein, so as to be kept in association with one another, an identifier of the workflow, the execution state of the workflow, an execution time of the workflow, and a deletion Application Programming Interface (API) for deleting the workflow; and
deleting any of the controlled elements related to the workflow of which the execution state is indicated as having failed, by searching for the identifier of the workflow of which the execution state is indicated as having failed based on the execution time of the workflow and obtaining and executing the deletion API corresponding to the identifier of the workflow found in the search.

13. The workflow integrity ensuring method according to claim 12, wherein the workflows are workflows having a multi-layered structure, as the identifiers of the workflows,
storing therein an identifier of a workflow in an upper layer and an identifier of a workflow in a lower layer so as to be kept in association with each other; and
as the execution times of the workflows, storing therein a controlled element reflection time at which content of the REST API was reflected on the controlled element and a system reflection time at which the content of the REST API was executed as an order.

14. The workflow integrity ensuring method according to claim 13, further comprising: performing, regardless of a workflow execution process performed by an execution unit that executes the workflows related to the controlled elements, a hidden registration process to register pieces of data in the history information received from the execution unit into the storage unit.

15. The workflow integrity ensuring method according to claim 14, wherein the controlled elements are a plurality of service processing units for providing a requested service.
